(19) United States
(12) Patent Application Publication
(10) Pub. No.: US 2024/0286936 A1
(43) Pub. Date: Aug. 29, 2024

(54) SYSTEM AND METHOD FOR ELECTROENERGIZING WATER AND AQUEOUS SOLUTIONS FOR USE IN AGRICULTURE AND LIVESTOCK FARMING, ELECTROENERGIZED FLUID AND CORRESPONDING USE

(71) Applicants: Charles Adriano Duvoisin, Balneario (BR); Fabio Eduardo Baggio, Curitiba (BR)

(72) Inventors: Charles Adriano Duvoisin, Balneario Camboriu (BR); Fabio Eduardo Baggio, Curitiba (BR)

(21) Appl. No.: 18/571,572

(22) PCT Filed: Jun. 21, 2021
(86) PCT No.: PCT/BR2021/050267

§ 371 Date: Dec. 18, 2023

(51) Int. Cl. C02F 1/48; C02F 103/02; C02F 103/20

(52) U.S. Cl. CPC C02F 1/487; C02F 2103/02; C02F 2103/20

(57) ABSTRACT

The present invention relates to a system and method for electroenergizing water and aqueous solutions (100) for agriculture and livestock farming, comprising an electron trap (200), a fluidic circuit (300), a control unit (400), an interface (500), and a dispensing device (600), wherein the electron trap (200) is provided with a housing (201), at least one cathode (210) with at least one internal electrode (220) disposed within the housing (201), and at least one anode (230) with at least one external electrode (233) disposed between the inside and the outside of the housing (201) in a recess thereof, wherein the external electrode (233) partially remains inserted into the housing so as to have 5 to 80%, preferably 15 to 70%, preferably 20 to 60% of its volume inside the housing (201), wherein the external electrode (233) has free surfaces and/or surfaces with rounded ends, both upstream and downstream of the flow of a fluid (F) passing through the electron trap (200).

### TECHNICAL FIELD

The present invention belongs to the field of systems, methods, devices and materials for treating and purifying water or aqueous solutions for use in agriculture and livestock farming.

### INTRODUCTION

The present invention relates to a system and method for treating and purifying water or aqueous solutions, more specifically through the electroenergization of water or aqueous solutions. The present invention also relates to an electroenergized fluid and the use of this fluid in agricultural and livestock applications.

### BACKGROUND OF THE INVENTION

The damage caused by ingesting or using contaminated or untreated water is widely known. When ingested by animals, they may experience diseases and symptoms similar to those in humans, such as fevers, botulinum poisoning, and diseases linked to parasites and microorganisms. Poisoning and harm to the digestive system and intestinal tract resulting from the presence of heavy metals and residual toxins are also common.

When used for irrigation and plant and vegetable care, these damages include underdevelopment or interrupted growth of vegetables, changes in their appearance, smell, and flavor, and harm to the surrounding ecosystem. Furthermore, the presence of toxins and heavy metals can leave residual traces in vegetables, which, when consumed by animals and humans, can lead to health implications and illnesses as those mentioned above.

Several solutions in the art aim to prevent the onset and spread of these damages and diseases. These solutions include the use of physical filters, synthetic resin ion-exchange, electrolysis, distillation, and oxidation through radiation, among others.

However, it should be noted that the prior art lacks versatile and cost-effective solutions that leverage the properties and advantages offered by electron traps as water purification and treatment agents.

Electron traps enable, for example, the treatment of water or aqueous solutions by removing and eliminating dirt, bacteria, and microorganisms quickly and at a low cost. They also allow the alteration of the physical-chemical properties of the fluids, such as changes in pH and surface tension.

An electron trap according to the present invention facilitates the controlled electroenergization of fluids. It can induce both acidification and alkalinization of the fluid being processed, adapting to the type of application and the targeted living organism. It also allows for the reduction of the fluid's surface tension, optimizing flow conditions and reducing infrastructure and energy costs.

### PRIOR ART

Known prior art solutions for obtaining hydrogen-modified graphene networks can be found in prior art documents such as US patent WO 2014/153338, entitled “Method and apparatus for conditioning fresh and saline water”, which relates to a method and apparatus for conditioning water, wherein the water is flowed past a probe. The probe is energized to excite the water and a presence of electrons in the excited water is reduced to produce positively charged water downstream of the probe, which causes impurities to dissociate from the water. The excited water may be deposited on the soil for agriculture and livestock farming. The excited water may be further deposited on the soil to flush impurities in the soil to a depth away from a root of a crop planted in the soil to reclaim the soil for agriculture and livestock farming. The excited water can also be used to decalcify pipes, such as those used in irrigation, heat exchangers, cooling systems, etc. In yet another embodiment, the probe may be energized at a frequency selected to destroy some type of organism, thereby protecting ecosystems.

However, it is important to note that WO 2014/153338 does not provide instructions for creating an electron trap. Its teachings involve low voltage and high frequency, providing simple electrolysis. As an obvious consequence of this solution, water undergoes a temperature change. Furthermore, the teachings rely on grounding the water flow, preventing the formation of an electron trap. Finally, it is noteworthy that the method and apparatus disclosed by WO 2014/153338 offer less versatility in applications and fewer user control capabilities.

Another relevant prior art document is US 2002/0168418, entitled “Method and apparatus for treating water for use in improving the intestinal flora of livestock and poultry”, which describes a water treatment system to improve the intestinal flora of livestock and poultry. The treated water for livestock and poultry use provides water with increased dissolved oxygen such that when the treated water is ingested, the livestock and poultry have increased lactic acid-producing bacteria and decreased coliforms in the intestine. Increasing the molecular oxygen content in the intestine by providing the birds with treated water containing a higher level of dissolved oxygen alters the balance of flora in favor of the beneficial bacteria, thereby improving bird health and performance. By reducing the numbers of strict anaerobes in the gut of the growing bird, the risk of infectious disease, and hence morbidity and mortality are reduced. This allows the beneficial bacteria to proliferate, thereby enhancing the digestion and absorption of available nutrients to the bird. The final effect of enhancing the conditions for the proliferation of beneficial bacteria like Lactobacilli, and suppressing pathogenic bacteria like Salmonella, Shigella, Staphylococcus, Escherichia coli, Clostridium, and Helicobacter pylori, is greater body weight, enhanced feed efficiency, and healthy animals requiring less use of antibiotics. The system includes a water treatment filter, a flow meter that coordinates with a flow switch, and an electrocatalytic cell coupled to a holding chamber that is connected to an outlet on the cell.

However, US 2002/016841 also does not provide conditions for creating an electron trap. Once again, simple electrolysis is noted, and the ineffective water energization is also observed. Furthermore, the formation of by-products raises concerns when implementing this method, considering the goal of providing water with increased dissolved oxygen. Finally, handling water treated by this method also entails additional costs and concerns during post-processing, in addition to a clear reduction in fluid flow due to variations in pipe diameter. For all the reasons above, it is evident that the objects in document US 2002/016841 are complex to install, expensive, and offer little practicality to the user.

Finally, it is worth noting that several prior art solutions can be found in other patent documents, such as U.S. Pat. Nos. 9,011,700. 9,011,700, 6,802,956, and CA 2689646. In these documents, we find both attempts to treat water through electrolysis and solutions that rely on other compounds and fluids in an effort to purify, treat, or energize water. However, teachings providing a method of treating and purifying water using an electron trap cannot be obtained from these documents.

There are several advantages to using electron traps for diverse applications, including energy consumption efficiency (compared to simple electrolysis), ease of adaptation in various practical systems, both dynamically and in batches, simple and cost-effective commercial application, high processing speed, and a clean and sustainable process.

Thus, considering the teachings of the prior art, there is a clear demand for a method and system for treating water or aqueous solutions and equipment for conveying treated water that resolves problems not addressed by the relevant prior art.

Therefore, the subject matter now disclosed aims to solve these problems through a system and method for treating and purifying water and aqueous solutions through the electroenergization of water and aqueous solutions subjected to an electron trap. Additionally, it aims to provide equipment for conveying and supplying this livestock production.

### OBJECTS OF THE INVENTION

One of the objects of this invention is to provide a system for electroenergizing water and aqueous solutions for agriculture and livestock farming, in accordance with the features of claim 1 of the appended claims.

Another object of this invention is to provide a method for electroenergizing water and aqueous solutions for agriculture and livestock farming, in accordance with the features of claim 12 of the appended claims.

Another object of this invention is to provide an electroenergized fluid, according to the features of claim 14 of the appended claims.

Yet another object of this invention is the use of an electroenergized fluid, in accordance with the features of claim 16 of the appended claims.

Additional features and details thereof are presented in the dependent claims.

### DESCRIPTION OF THE DRAWINGS

To better understand and visualize the subject matter, the present invention will now be described with reference to the appended drawing, illustrating the achieved technical effect through exemplary embodiments without limiting the scope of the present invention.

FIG. 1 shows a diagram of an electron trap according to the invention;

FIG. 2 shows a partial sectional side view of an electron trap module of the invention;

FIG. 2a shows a partial front view of an electron trap module of the invention;

FIG. 3 shows the system of the invention applied to agricultural scenarios involving plant irrigation and animal hydration, depicting the placement of an electron trap in the fluidic circuit upstream of a dispensing device;

FIG. 4 shows the system of the invention applied to agricultural scenarios involving plant irrigation and animal hydration, depicting the placement of one or more electron traps in the fluidic circuit downstream of a dispensing device;

FIG. 5 shows the system of the invention applied to agricultural scenarios involving plant irrigation and animal hydration, depicting the placement of one or more electron traps in the fluidic circuit upstream and downstream of a dispensing device;

FIG. 6 shows the system of the invention applied to agricultural scenarios involving plant irrigation, depicting the placement of an electron trap in the fluidic circuit without a dispensing device; and

FIG. 7 shows the system of the invention applied to agricultural scenarios involving plant irrigation and animal hydration, depicting the placement of an electron trap along the fluidic circuit.

### DETAILED DESCRIPTION OF THE INVENTION

The following detailed description refers to the appended drawings in which, by way of non-limiting illustration, embodiments of the present invention are shown. These embodiments are described to enable a person skilled in the art to reproduce the results. Other embodiments resulting from structural, mechanical, logical, and electrical changes are possible and can be performed without departing from the spirit and scope of the present invention. The following detailed description should therefore not be understood in a restrictive or limiting manner.

To enhance comprehension and structure the details of the present invention, the following description will be organized into topics based on the objects of the invention.

### System

A system for electroenergizing water and aqueous solutions according to the invention, or simply system (100), comprises:
I. an electron trap (200);
II. a fluidic circuit (300);
III. a control unit (400);
IV. an interface (500); and
V. a dispensing device (600).

A system (100) according to the invention comprises the targeted operation of one or more electron traps (200), modifying an initial fluid (IF) through electron sequestration (electroacidification) or electron accumulation (or electroalkalinization), controlling the electric potential difference, and obtaining an energized final fluid (FF) in a targeted and controlled manner.

A fluid (F) according to the invention is an electroconductive fluid of any nature, selected from, but not limited to, fluids from the group comprising water, mineral water, medicated emulsions, liquid or dissolved or liquefied medicines, fertilizers, hydroponic fluids, colloids, stimulants, dewormers, juices, concentrates, pulps, extracts, emulsions, ointments, creams, pastes, gels, and the like, which may be alcoholic or non-alcoholic, carbonated or non-carbonated. A fluid (F) according to the invention can also comprise food, as long as it has sufficient fluidity for passage through pipes and is preferably pumpable.

A fluid medium (F) according to the invention is a formulation comprising one or more fluids according to the invention and may also comprise additional fluids such as preservatives, colorings, stabilizers, flavorings, emulsifiers, sweeteners, and other related elements, commonly used in the aforementioned fluids, in particular for agribusiness applications. For the purposes of clarity in the present description, the term ‘fluid’ (F) will be used preferentially, but not exclusively, to denote water and/or the aqueous solution, comprising, however, all possible forms described above.

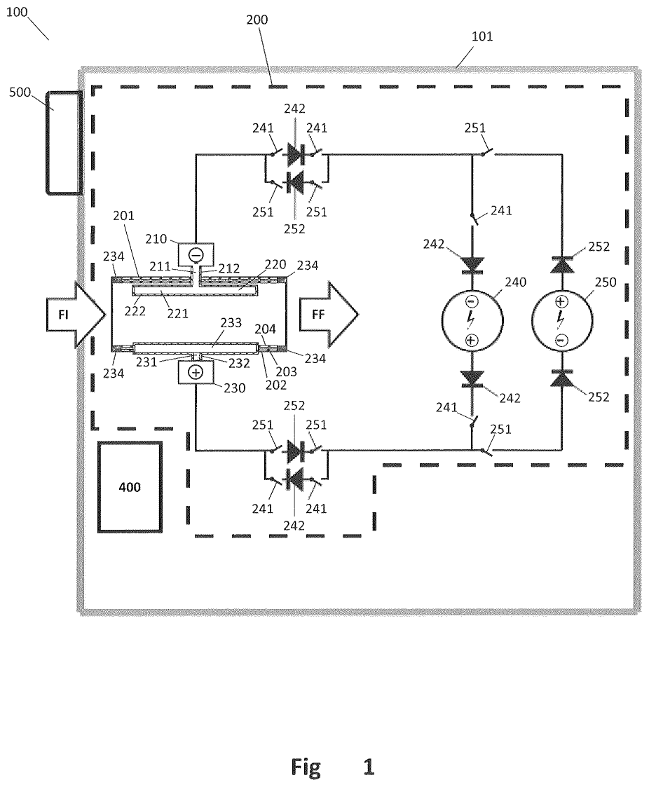

An electron trap (200) according to the invention is a device for electroenergizing fluids (F) provided with a housing (201), at least one cathode (210) connected to at least one internal electrode (220) inside the housing (201), at least one anode (230) connected to at least one external electrode (233) disposed in a recess in the housing (201), and at least two power sources (240, 250) connected to the circuit comprising cathode (210), internal electrode (220), anode (230), and external electrode (233), as depicted particularly in FIG. 1.

The housing (201) of the electron trap (200) consists of at least one outer layer (202) made of dielectric material, an intermediate layer (203) made of electrically conductive material, and an inner layer (204) made of dielectric material. The outer (202) and inner (204) layers are designed to isolate the intermediate layer (203) made of electrically conductive material from contact with the surface, other electrically conductive materials, or the fluid (F) to be energized by the equipment (100). The housing (201) may be a simple housing and/or a tube and/or part of the piping that will carry the fluid (F), which can be water or an aqueous solution, or any element coupled to a fluidic circuit (300). The housing (201) must include insulation (234) at its ends to prevent electrical contact with the piping or any other component of the fluidic circuit (300) made of conductive material and/or with insufficient dielectric strength relative to the characteristics of the application and that may, eventually, allow the transmission of electric current based on a certain voltage/current and also avoid contact with other conductive and/or grounded objects. In general, the elements described herein can also be solid and coated with suitable isolating layers, such as polymers, paints, coatings, and other forms suitable for isolation under the conditions described and required by the invention.

It should be noted that electrically conductive materials and electrical dielectric or insulating materials are widely known in the art. These include, but are not limited to, copper, stainless steel, graphite, graphene, aluminum, and the like in the case of conductors, and PP, PE, polymers, ceromers, glasses, and the like in the case of dielectrics.

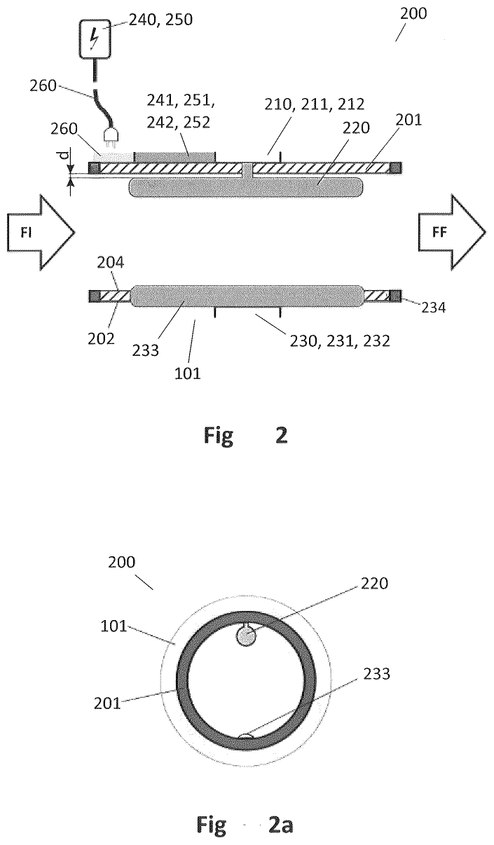

The electron trap (200) is designed to form a module housed within a suitable casing, box, or enclosure (101), which can be either portable or fixed. This enclosure can even be the housing (201) itself, which houses the other constituent elements of the electron trap (200) in casings coupled to the housing (201), as illustrated non-exhaustively in FIG. 2.

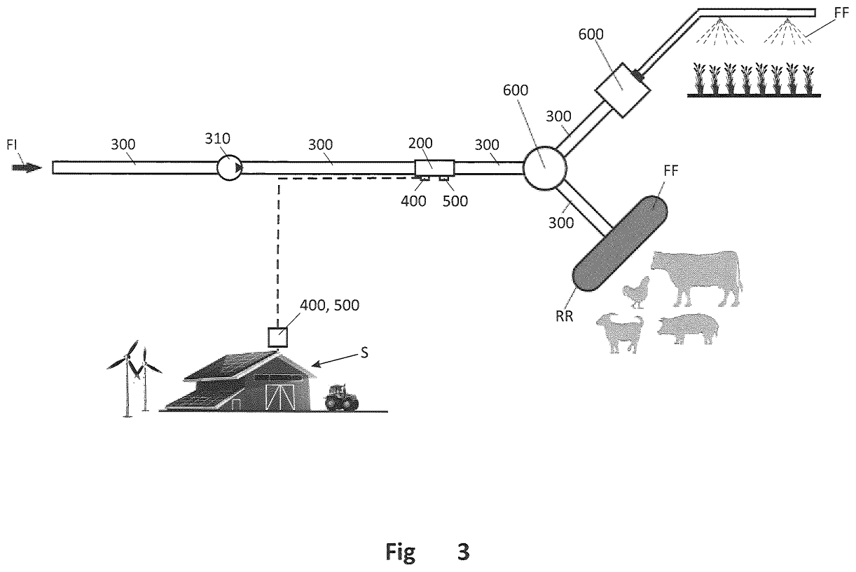

Due to its modular design, the electron trap (200) can be disposed in any position or section of the fluidic circuit (300) based on the requirements of each system's construction, as depicted particularly in FIG. 3.

The external electrode (233) must be located between the inside and the outside of the tube, in a recess in the housing (201), remaining partially inserted to have 5 to 80%, preferably 15 to 70%, more preferably 20 to 60% of its volume disposed inside the housing (201). The position of the recess must be such as to ensure the correct placement of the external electrode (233) in relation to the internal electrode (220), this position being preferably diametrically opposite to that of the internal electrode (220). Moreover, the external electrode (233) has free surfaces and/or surfaces with rounded ends, both upstream and downstream of the flow, which, together with its partial insertion, enhances its hydrodynamic characteristics, thereby reducing friction between the external electrode and the fluid. Notably, electroenergization occurs as the fluid (F) passes through the electron trap (200) and contacts the electrodes (220, 233), being therefore also influenced by the contact time, wherein some solutions of the prior art teach the reduction of the inner diameter of the electron trap (200) relative to the diameter of the supply pipe. However, in applications requiring continuous flow, such as irrigation, flow reductions and/or retentions are undesirable. The present invention provides an electron trap (200) with an inner diameter closely matching that of the fluidic circuit (300) in the interface regions therewith. This, combined with other features of the electron trap (200) of the invention, ensures not only the perfect electroenergization of the fluid (F) but also avoids compromising the flow.

The external electrode (233) must be painted or coated with electrical insulating material on the portion projecting outside the housing (201), in the regions of direct contact between the external electrode (233) and the housing (201). Additionally, in the part facing the inside of the housing (201), this portion may, for example, lack insulation or even have a smaller amount of insulating material than the rest of the external electrode (233).

The inner layer of the tube (204) may also lack or even have a smaller amount of insulating material than the outer layer (202) to facilitate the guidance of the flow of electrons in the electron trap (200). The outer layer (202) or outer part of the tube or housing (201) must be fully isolated to prevent electron leakage. This effect is associated with the “Leyden bottle” principle.

The cathode (210) of the system (100) consists of an inner layer (211) made of electrically conductive material and is coated with an outer layer (212) made of dielectric material intended to isolate the inner layer (211) from contact with the surface, other electrically conductive materials, or the fluid (F) to be energized by the electron trap (200) of the equipment. In the preferred embodiment depicted in FIG. 1, said cathode (210) is connected to at least one internal electrode (220). The elements described herein can also be solid and coated with appropriate isolating layers, such as polymers, paints, coatings, and other forms suitable for insulation under the conditions described and required by the invention.

The internal electrode (220), similarly to the cathode (210), consists of an inner layer (221) made of electrically conductive material and is coated with an outer layer (222) made of dielectric material for proper insulation. The internal electrode (220) is positioned within the housing (201), electrically isolated from it, being at a distance (d) from the inner wall of the tube that corresponds to 0 to 20%, preferably 1 to 10%, preferably 2 to 5% of the diameter (or internal measurement) of the housing (201). The internal electrode (220) has free surfaces and/or surfaces with rounded ends, both upstream and downstream of the flow, thereby increasing its hydrodynamic characteristics and reducing friction between the external electrode and the fluid. The elements described herein can also be solid and coated with appropriate isolating layers, such as polymers, paints, coatings, and other forms suitable for insulation under the conditions described and required by the invention.

The anode (230) comprises an inner layer (231) made of electrically conductive material and is coated with an outer layer (232) made of dielectric material intended to isolate the inner layer (231) from contact with the surface or fluid (F) to be energized by the equipment. The anode (230) may or may not be in electrical contact with the housing (201) upon insertion.

In one embodiment of the invention, both the anode (230) connected to the external electrode (233) and the cathode (210) connected to the internal electrode (220) are electrically isolated from the housing (201). However, it is also possible for the anode (230) and/or the cathode (210) to be in electrical contact with the housing (201), depending on the requirements of the application.

The electrodes (220, 233) must be made of conductive material with properties suitable for the voltage and electrical current of the electrical power sources (240, 250) to prevent fluid (F) contamination. Preferably, these materials include oxide-based elements to enhance electroenergization performance through the use of targeted and controlled semiconductors. Materials such as stainless steel or with stainless steel surface treatments can also be considered, in addition to ceramic materials, metal oxides, graphenes, fullerenes, and other suitable materials, without limitation.

The electron trap (200) further comprises two power sources (240, 250) with adjustable voltage, preferably direct current with pulsed current, wherein a positive source (240) is intended for electron sequestration (electroacidification) and a negative source (240) (250) is intended for electron accumulation (electroalkalinization).

The power sources (240, 250) are switchable and connected to the circuit through a set of switches (241, 251), and the circuit further comprises a set of diodes (242, 252) to ensure the correct direction of current flow based on the selected source (240, 250) for supplying the electron trap (200) and, thus, prevent reverse currents during the electroenergization process, facilitating complete ionization in accordance with parameterization. It should be noted that one or more of the diodes (242, 252) may eventually be replaced with contactless spark gap devices or spark gaps, preferably disposed near the cathode (210) and anode (230).

The electroenergization conditions are essentially determined by the type of source (240, 250), the voltage and current applied by the source (240, 250) to the circuit, and the operating time of the electron trap (200). The choice of these three parameters is based on the chosen type and intensity of electroenergization, providing the user with the option of inducing either electroacidification or electroalkalinization of the initial fluid (IF), transforming it into a suitable final fluid (FF) for the intended application.

The selection of the source (240, 250), the input for the voltage and current values of the sources (240, 250), and the control of the operating time of the sources (240, 250) are operations performed and controlled by a control unit (400), which assigns a predetermined triple source/voltage-current/time protocol to each operating instruction according to the user's instructions. Each instruction corresponds to an ionization condition suitable for the intended application.

It should be noted that the ionization condition for preparing the fluid (F) to be used for irrigation purposes may vary from the preparation method used for animal hydration, and there may also be differences within the same category, for example, a preparation method suitable for certain types of birds may differ from the preparation method suitable for use with cattle, just as the method for irrigating lettuce may differ from the method for irrigating grape vines, and so on.

In the equipment according to the invention, electroenergization can be utilized for both electron sequestration (positive direction—electroacidification) by selecting the positive source (240) and electron accumulation (negative direction—electroalkalinization) by selecting the negative source (250), allowing to obtain the exact quantity of ions with the desired charges (positive or negative direction) and facilitating eventual adjustments and corrections of the fluid ion levels (F) during the process (mixed or alternating direction) to achieve a final fluid (FF) with the desired characteristics, predetermined by the intended application and purpose of the fluid (F) and its energization.

In the context of the present invention, ‘electron trapping’ means that, in the case of the energized fluid, negative ions migrate towards the positive pole of the constant-polarity electric current immersed in the fluid, resulting in the desired excess of hydrogen ions (H+) or cations, leading to the consequent increase in the fluid's acidity, herein referred to as electroacidification. The source selected in this case is the positive source (240).

In the context of the present invention, ‘electron accumulation’ means that, in the case of the energized fluid, positive ions migrate towards the negative pole of the constant-polarity electric current immersed in the fluid, causing a desired excess of hydroxide ions (OH—) or anions, leading to the consequent increase in the fluid's alkalinity, herein referred to as electroalkalinization. The source selected in this case is the negative source (250).

According to the invention, the user will be able to choose the electroacidification level by selecting one or more of two or more options that will be assigned to the corresponding triple protocol(s) by the processor.

It should be noted that, regardless of the use of a DC or AC power source, practical tests complementing the studies of the present invention make it evident that the higher the applied tension, the better and more intense is the harmonization of the resulting electron flow within the fluid. The choice of the intensity of the electric current follows the same reasoning, i.e., the greater the applied current, the more uniform the flow of electrons.

These considerations, however, should not be construed as limiting the applications of the present invention, as the choice of electrical voltage and current levels will depend on factors such as the type of fluid chosen, the conditions and properties of the fluid, the container or reservoir containing it, any objects totally or partially immersed in it, and other conditions that may influence the dielectric characteristics of the assembly.

That said, the use of both low and high voltages and currents must be considered, with the use of pulsed direct current being preferred. For high-voltage generating sources, we have the Van der Graaf source or trivial sources, capable of generating unilateral pulsed or non-pulsed currents. Electrical voltages can vary within a range of 110 V to 1 GV, preferably within the range between 50 and 500 kV. The frequency of the electrical pulses can range from 60 Hz to 1×10¹⁵ Hz, preferably within the range of 60 to 1 kHz.

Power sources (240, 250) suitable for providing electrical power according to the invention are pulsed direct current sources designed to enable electric potential differences between 1 kV and 100 GV, preferably, but not limited to a range between 10 kV and 10 GV. The choice of voltage will essentially depend on the type of fluid (F) to be energized, the intended energization time, and the presence or absence of objects immersed in the fluid, in addition, of course, to the dielectric characteristics of the equipment and its components and, eventually, of the container. The values cited herein should not be construed as limiting the scope of the invention and may be higher or lower than indicated, depending on the necessary electroenergization conditions.

Suitable electrical power sources (240, 250) according to the invention are pulsed direct current sources designed to enable electrical currents ranging from 1 μA to 1 kA, preferably, but not limited to, from 1 mA to 100 A. The choice of electric current intensity will depend primarily on the type of fluid (F) to be energized, the intended energization time, and the presence or absence of objects immersed in the fluid (F). The electrical power sources (240, 250) can be powered by the existing power grid or alternative sources such as solar panels, wind turbines, etc. The values and citations should not be construed as limiting the scope of the invention and may vary, being higher or lower than indicated, based on the necessary electroenergization conditions.

The operating time of the electron trap (200) ranges from 10 ms to 120 s, preferably, but not limited to a duration between 100 ms and 60 s. The fluid flow is directly correlated with the time corresponding to the triple protocol selected by the consumer using the interface (500).

It is crucial to emphasize that the electrical voltage applied to the initial aqueous formulation at this stage must be concurrent with the materials used in the electron trap (200), ensuring it is sufficient to surpass the dielectric strength of the insulation at the desired locations. This enables the flow and subsequent trapping (after removal from grounding) of electrons within it, facilitating the entrapment of electrons within the fluid and, consequently, the electroenergization of the aqueous formulation.

In the case of positive targeting or electron sequestration, a positive differential is created, leading to the consequent acidification of the fluid. In this type of process, the electrostatic sensitivity of the final fluid (FF) occurs between the positive charges of the fluid and the electrons.

In the case of a negative direction or electron accumulation, a negative differential is created, resulting in the consequent alkalinization of the fluid. In this type of process, the electrostatic sensitivity of the final fluid (FF) takes place between the electrons in the fluid and the positive charges.

According to the invention, the user will then be able to choose the level of electroacidification or electroalkalinization by selecting one or more of two or more options, which will be assigned to the corresponding triple protocol(s) by the processor. It should also be noted that the size (capacity) of the fluidic circuit (300) and the fluid flow rate (F) play a significant role in influencing the ionization intensity of the resulting final fluid (FF), as larger pipe sizes and/or higher flow rates result in a greater number of electrons to be sequestered or accumulated. Additionally, construction features such as thickness and the chosen material also impact the final outcome. Therefore, the capacity values mentioned above serve only as a reference.

An electron trap according to the present invention facilitates the controlled electroenergization of fluids. It can induce both acidification and alkalinization of the fluid being processed, adapting to the type of application and the targeted living organism. It also allows for the reduction of the fluid's surface tension, optimizing flow conditions and reducing infrastructure and energy costs. This reduction should be understood as the decrease in the surface tension of the fluid (F) during the process until reaching surface tension values of the final fluid (FF) that are lower than those of the initial fluid (IF), under similar pressure and temperature conditions.

A fluidic circuit (300) according to the invention primarily comprises a main pipe that fluidly connects the passage of water or aqueous solution to the electron trap (200) and one or more dispensing devices (600), and may also eventually comprise a fluid pump (310) and/or a cooling/heating device or equipment (320) for cooling and/or heating the fluid (F) during the process, a pressure switch or pressure actuator or the like, along with floats, pressure gauges, traps, safety valves, return valves, and other customary accessories and devices for fluid dispensing.

The dispensing device (600) within the fluidic circuit (300) can take the form of a distributor, a bypass, an end point, a fluidic connection, a coil, etc., while a container (RR) can be designed as a trough, a drinker, a tank, a container, etc.

The use of the fluid pump (310) is not limiting to the scope of the present invention. The force of gravity can also be employed, depending on the system assembly (100) and need.

The system (100) of the invention may comprise one or more fluidic circuits (300), identical or different from each other.

It is worth mentioning that the electron trap (200) must be electrically isolated from the enclosure (101) and also from the structure and elements of the fluidic circuit (300) by means of, for example, insulation (234) or other isolators.

As shown in FIG. 2, each electron trap (200) forms an autonomous module inserted, for example, in an enclosure (101) that accommodates, surrounds, and protects all elements of the electron trap (200), with the exception of the power sources (240, 250) that can either be coupled to the housing (201) or disposed externally to the housing (201), being then connected to the electron trap (200) elements through a connection (260) with a connection element (261) that can be a cable with plug or the like, as long as suitable.

Each module may further comprise at least one control unit (400) and/or at least one interface (500), wherein the modules may be integrated into different sections of the fluidic circuit, either with or without one or more fluidic pumps (310). Similarly, the quantity of electron traps (200) or fluid pumps (310) can be multiplied as needed. The interface (500) is capable of remote monitoring and can be installed, for example, at the user's or administrator's farm headquarters (H) or another location remote from the application. Additionally, a control unit (400) may also exist remotely, located at the user's or administrator's farm headquarters (H) or another location remote from the application. This allows for the activation of the system and/or remote adjustments to energization and/or flow parameters.

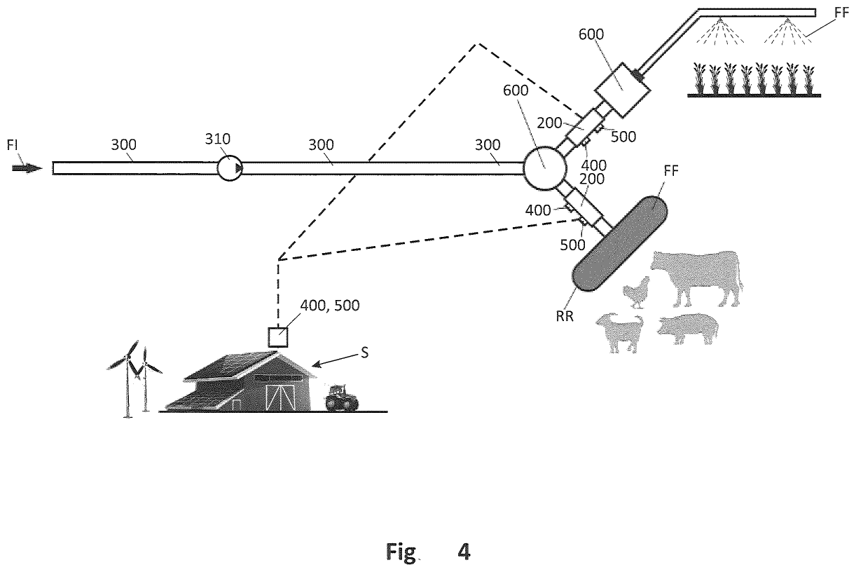

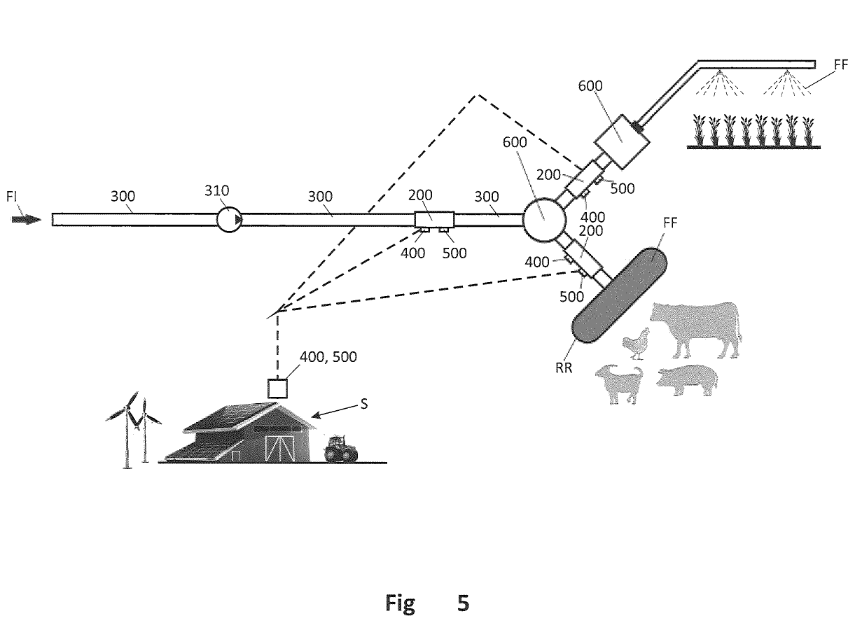

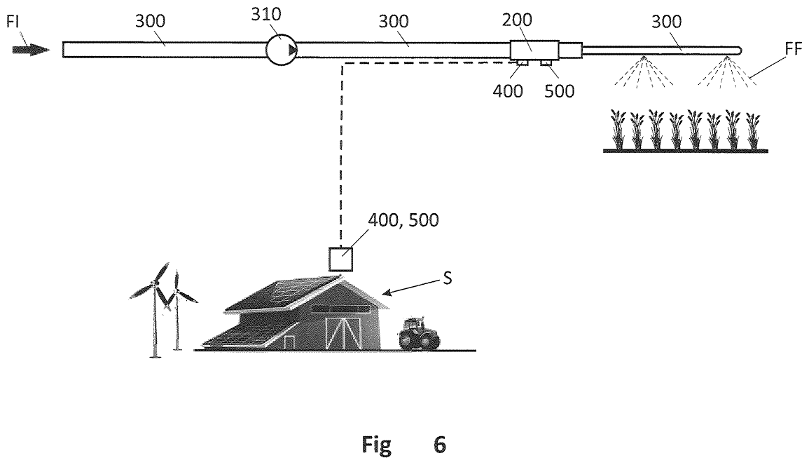

The optimal placement of an electron trap (200) in the fluidic circuit is preferably as close as possible to the dispensing device (600). It can be connected either upstream (FIG. 3) or downstream (FIG. 4) of the dispensing device or both upstream and downstream (FIG. 5), or as close as possible to the point where the final fluid (FF) is used, for example, in the absence of a specific dispensing device (600) (FIG. 6), or even at the end of the fluidic circuit (300). In this manner, electrical losses are minimized, maintaining the effects of electroenergization for as long as possible. Additionally, it simplifies installation conditions and reduces infrastructure costs for supplying electron traps (200).

However, it should be noted that the number of electron trap (200) modules, along with the length of the fluidic circuit (300) and dispensing devices (600), depends on the conditions of each application, including climatic and topographical conditions, the distance between the water source and the piping for optimal distribution according to the specific needs (irrigation, hydration, or feeding).

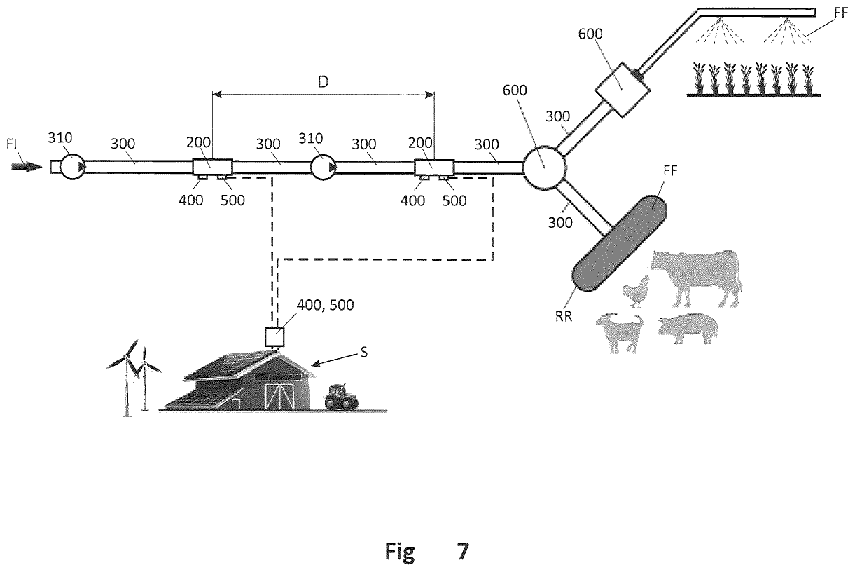

In situations where water or an aqueous solution is distributed over larger sections of piping and/or greater distances, whether for irrigation, hydration, animal feeding, or similar purposes, it might be necessary to provide more electron traps (200) along the piping, which are spaced apart at distances (D) that will depend not only on trap features such as voltage, current, and application time, but also on the properties of the fluid (F) itself and the fluidic circuit (300), as illustrated particularly in FIG. 7. The primary parameters to consider concerning the fluid (F) include density, viscosity, and temperature, with factors such as pipe diameter, pressure, and required or intended flow being determinants of the fluidic circuit (300).

Consequently, the distance (D) between two or more electron traps (200) depends on the aforementioned factors. As a non-limiting example of the invention, the higher the flow rate and/or the lower the density and/or the lower the viscosity of the fluid (F), the lower the demand for more electron traps (200) and, therefore, the greater the distance (D) between them may be. This condition is particularly emphasized in cases of smaller diameter pipes.

Furthermore, as known in the art, it may also be necessary to install additional fluid pumps (310) to maintain pressure and compensate for pressure losses that typically occur due to water or aqueous solution friction with the inner walls of the piping.

A container (RR) or tank according to the invention is any container made of suitable insulating material, capable of maximizing the ionization time of the final fluid (FF) after dispensing by the dispensing device (600) and before its use in irrigation or consumption for animal hydration, while also mitigating the risk of grounding and potential charge leakage. It should be noted that the dielectric nature of the container does not affect the immediate availability of the final fluid (FF) for consumer consumption.

The housing (201) should preferably be a ceramic tube or similar insulating material, ensuring a smooth surface with mechanical and abrasion resistance. Its ends must include insulation (234) to prevent grounding and charge loss, as discussed above. Due to its modular design, the electron trap (200) can be easily coupled to the fluidic circuit (300) or even directly to the dispensing devices (600), such as the distribution pipes in existing irrigation systems. It can also be designed to be connected to the final part of the system (100) or irrigation system terminals. Moreover, it can supply feeders and hydrators for confined and semi-confined animals. These feeders and hydrators should preferably be isolated from the ground and be made of dielectric materials and/or materials preventing the discharge of electrons from the final fluid (FF) that feeds and hydrates animals, thus enabling electroenergization without loss of energy through grounding loads.

Pressure losses in a system (100) such as the one described herein are known in the prior art. What sets this invention apart is its ability to regulate the amount of electrons supplied by the system (100), thereby enhancing plant production and growth, while also accelerating the growth and significantly increasing the weight of animals consuming the treated water or aqueous solution.

The control unit (400) according to the invention is an integral part of the system (100) according to the invention, that includes at least one processor, database, and an interface (500) comprising devices for information/instruction acquisition and devices for displaying information/instructions, and other devices and/or equipment connected to the system (100), which operate together and may be, collectively or individually, interconnected by one or more communication and data networks. Images and data are stored as one or more electrical signals and the processing of these signals is carried out by one or more components of the control unit (400) and the system (100) as a whole.

A processor is, in the context of the invention, a central processing unit or CPU that performs the instructions of a computer program, processing and executing arithmetic, logical operations and data input and output, whereby the computer program is stored on a computer-readable medium having memory for data storage, connection to one or more communication and data networks, and having one or more, local and/or centralized and/or decentralized and/or cloud-based remote databases and/or an information storage and retrieval environment, and also equipped with all the usual state-of-the-art peripherals, being capable of exchanging information with electronic and physical media, interfaces, applications, mobile equipment, other memory devices, etc.

Moreover, a processor according to the invention can be, form part of, or be subdivided into one or more modules. The term module, according to the invention, refers to an application-specific integrated circuit (ASIC), an electronic circuit, a processor (shared, dedicated or group of processors) and a memory which executes one or more programs software or firmware. It further refers to a combinational logic circuit and/or other suitable components capable of providing the functionalities herein.

In the context of the invention, a databank or database refers to any and all sets of data, files, information, instructions, and reports constituting organized data collections that are interrelated and that can be accessed, input, and managed by the control unit (400) of the invention.

The system (100) of the invention comprises one or more control units (400) that can be identical or different from one another.

An interface (500), in the context of the invention, comprises an acquisition device and an information/instruction presentation device. It acts as an interface (500) between the control unit (400) and the users who will operate the system (100). This may include any device capable of processing, storing data and/or information, and communicating with the user and other users through a communication and data network, such as control conducted at the user's farm headquarters (H). It may also include physical, analog, digital, and similar sensors, measuring temperature, alkalinity, viscosity, flow rate, etc. of the fluid (F) to assist in monitoring and decision-making regarding adjustments to the parameters of the electron traps (200) as needed. Light sensors and combinations thereof, including compatible cameras and the like, along with dedicated or shared information presentation devices, in particular displays with or without buttons or keyboards, displaying, for example, options for water or aqueous solutions and their energization and which can receive instructions via touch, voice, telemetry, etc., allowing users to make choices and monitor the preparation (energization) of the water or aqueous solution.

The sensors may be configured, for example, to detect the bodily activity of one or more users near the system (100), being operationally and/or communicatively connected to one or more of the components of the control unit (400).

The interface acquisition device (500) of a control unit (400) of the invention, which may be a screen with or without buttons or a keyboard, can comprise any device capable of processing, storing data and/or information, and communicating with other devices. This may also include personal computers, servers, code readers, telemetry, biometrics, cell phones, tablets, laptops, smart devices (e.g., smartwatches), to operate the system (100), providing necessary instructions. Each information acquisition device may include one or more memories that store information and data and may execute one or more programs to perform various operations in preparing (energizing) the water or aqueous solution.

The interface presentation device (500) of a control unit (400) of the invention serves as an interface (500) between the system (100) of the invention and consumers, and may comprise a set of visual signaling devices capable of projecting and/or emitting and/or presenting images and lights and emit visual and sound signals, and may also include equipment and peripherals such as projectors, screens, televisions, monitors, lights in general, and other corresponding and similar elements.

The system (100) of the invention comprises one or more interfaces (500), identical or different from each other, which can be either close to or distant from each other.

An instruction set according to the invention consists of one or more instructions, sequential and/or non-sequential, unique and/or repeated, related to the energization of water or aqueous solutions following the corresponding triple protocol. The control unit processor (400) performs the operations of the electron trap (200) and fluid pump (310) according to the instructions received from the consumer. The instruction set is acquired and/or transmitted and/or stored by and in one or more components of the control unit (400). Instructions may be executed and/or stored by and in the processor, on an information presentation or acquisition device, and may also be stored in one or more databases or other computer-readable, volatile or non-volatile storage media.

Once the user accesses the system (100) through the control unit (400), the energization options, fluid (F) conditions, and other options stored in the memory of the control unit (500) will be displayed on the interface (500) display. The user is then prompted to select one or more options. After the selection is made through the interface (500), the control unit (400) retrieves, from its local or remote memory and/or database, the triple protocol parameters (positive or negative power source, voltage values, actuation time) for the electron trap (200) corresponding to the user's selection. The control unit (400) then controls the other components, activating the power sources (240, 250), the fluid pump (310), and additional elements of the fluidic circuit (300).

Therefore, the selection of the source (240, 250), input for voltage values, and power sources (240, 250) and the control of the operating time of the power sources (240, 250) are operations performed and controlled by a control unit (400), which assigns a predetermined triple source/voltage-current/time protocol (stored in the memory of the control unit (400)) to each operating instruction given by the consumer through the interface (500), according to user instructions.

As the electron trap (200) is supplied by one of the power sources (240, 250), an electron trap (200) is generated inside the housing (201) through at least one energized internal electrode (220), and ionization of the fluid (F) being processed occurs, sequestering electrons from it (positive source (240)—acidification) or accumulating electrons in it (negative source (250)—alkalinization), resulting in the final fluid (FF) being electroenergized.

The new technical effect achieved is a rapid and sterile targeted increase or decrease in the concentration of electrons (e-) in the fluid, causing a targeted and controlled imbalance chosen by the user in the electrical charges in the atoms of the fluid molecules, trapping ions with both an excess (anions) and a deficit (cations) of electrons (e-), according to the need and type of intended use (irrigation, hydration, etc.).

### Method

A method for electroenergizing fluids according to the invention is a method performed by a system (100) according to the invention, comprising the following method steps:
i. providing an initial fluid (IF) by a fluid pump (310);
ii. displaying the energization options and fluid (F) conditions on the interface display (500);
iii. displaying additional options relating to the fluid (F) on the interface display (500);
iv. selecting one or more of the available options via the interface (500);
v. processing the selection information and accessing the database and/or equipment memory;
vi. assigning a triple protocol to the selection, with corresponding parameterization contained in the database and/or system memory (100);
vii. activating the system components (100) and inducing the flow of the initial fluid (IF) through the electron trap (200) and the electrodes (220, 233), and transforming it into the electroenergized final fluid (FF); and
viii. distributing the final fluid (FF) through the passage and distribution piping for agriculture and livestock farming.

It should be noted that the method according to the invention may have other accessory steps, before and after those described above, according to the technical knowledge and practices necessary for the operation of a system (100). Furthermore, some steps can be repeated individually or in groups, regardless of whether they follow the same sequence.

Finally, it is evident that, according to the invention, the user of the system (100) and corresponding method can promptly choose the intensity of both electroacidification and electroalkalinization and, thereby determining the desired ionization result. This selection is made by choosing one or more from two or more alternatives, assigned to the corresponding triple protocol(s) by the control unit processor (400).

### Electroenergized Fluid

An electroenergized fluid according to the invention is a final fluid (FF) obtained by electroenergizing an initial fluid (IF) through a system (100) performing a method according to the invention, wherein the final fluid (FF) has a different pH and a surface tension equal to or lower than the corresponding values of the initial fluid (IF).

### Use of an Electroenergized Fluid

The use of a final fluid (FF) according to the invention is intended for supplying irrigation systems, with the capability for self-correction of soil acidity, and increasing production and growth of irrigated crops, as well as for feeding and hydrating animals, thus significantly enhancing growth and weight gain.

### Final Remarks

The set of elements and devices required for the completion of the system (100) is readily accessible and familiar to those skilled in the art, without the need for parts, components, or any other apparatuses that are difficult to access or require intricate assembly.

Another advantage provided by the present invention is the low power consumption, given the very nature of the construction of the present electron trap (200). This contributes to the commercial viability of a system like the one described herein, applying the method of the present invention. Another direct result of this feature is a more sustainable approach to water consumption when implementing the subject matter described herein. On the other hand, the energy and resource expenditure in commonly used water treatment processes (including processes with chemical compounds, physical filtration or exposure to radiation) turns out to be a major commercial hindrance.

### CONCLUSION

It will be easily understood by one skilled in the art that modifications may be made to the present invention without departing from the concepts set out in the description above. Such modifications should be considered as included within the scope of the present invention. Consequently, the particular embodiments previously described in detail are merely illustrative and exemplary, and not limiting in terms of the scope of the present invention, to which the full extent of the accompanying claims should be given, in addition to all and any equivalents thereof.

1. A system for electroenergizing water and aqueous solutions, characterized in that it comprises:
I. an electron trap (200),
II. a fluidic circuit (300),
III. a control unit (400),
IV. an interface (500), and
V. a dispensing device (600),
wherein the electron trap (200) is provided with a housing (201), at least one cathode (210) with at least one internal electrode (220) disposed inside the housing (201), at least one anode (230) with at least one external electrode (233) disposed between the inside and the outside of the housing (201) in a recess thereof, wherein the external electrode (233) remains partially inserted in the housing so as to have from 5 to 80%, preferably 15 to 70%, preferably 20 to 60% of its volume inside the housing (201), wherein the external electrode (233) has free surfaces and/or surfaces with rounded ends, both upstream and downstream of the flow of a fluid (F) passing through the electron trap (200).

2. The system according to claim 1, characterized in that the internal electrode (220) is disposed at a distance (d) from the inner wall of the tube that corresponds to 0 to 20%, preferably 1 to 10%, preferably 2 to 5% of the diameter (or internal measurement) of the housing (201).

3. The system according to claim 1, characterized in that the electron trap (200) forms an autonomous module.

4. The system according to claim 1, characterized in that the electron trap (200) is positioned in the fluidic circuit (300) in a position near the dispensing device (600) or the location of use of the final fluid (FF) or the end of the fluidic circuit (300).

5. The system according to claim 1, characterized in that the electron trap (200) has an inner diameter closely matching the inner diameter of the fluidic circuit (300) in the interface regions therewith.

6. The system according to claim 1, characterized in that the housing (201) has insulation (234) at its ends.

7. The system according to claim 1, characterized in that the electron trap (200), the control unit (400) and the interface (500) form an autonomous module.

8. The system according to claim 1, characterized in that the electron trap (200) is powered by adjustable voltage sources (240, 250), preferably pulsed direct current, which are switchable and connected to the circuit via a set of switches (241, 251), wherein the circuit further comprises a set of diodes (242, 252) that induce either electroalkalinization or electroacidification and change the surface tension of the initial fluid (IF) to obtain a final fluid (FF).

9. The system according to claim 5, characterized in that the frequency of electrical pulses is from 60 Hz to 1×10¹⁵ Hz, preferably between 60 and 1 kHz.

10. The system according to claim 5, characterized in that the electrical power sources (240, 250) operate with electric potential differences ranging from 110 V to 1 GV, preferably from 50 to 500 kV.

11. The system according to claim 1, characterized in that the selection, input of voltage and current values, and control of the operating time of the sources (240, 250) are operations executed and controlled by the control unit (400), which assigns, to each operating instruction made through the interface (500), the parameterizations of a predetermined triple source/voltage-current/time protocol stored in a memory and/or database that is embedded in, or remote from, the control unit (400), which corresponds to one or more instructions from a consumer or user of the equipment (500).

12. Method for electroenergizing water and aqueous solutions, characterized in that it is performed by equipment (100) as claimed in claim 1 comprising the following method steps:
i. providing an initial fluid (IF) by a fluid pump (310);
ii. displaying the energization options and fluid (F) conditions on the interface display (500);
iii. displaying additional options relating to the fluid (F) on the interface display (500);
iv. selecting one or more of the available options via the interface (500);
v. processing the selection information and accessing the database and/or equipment memory;
vi. assigning a triple protocol to the selection, with corresponding parameterization contained in the database and/or system memory (100);
vii. activating the system components (100) and inducing the flow of the initial fluid (IF) through the electron trap (200) and the electrodes (220, 233), and transforming it into the electroenergized final fluid (FF); and
viii. distributing the final fluid (FF) through the passage and distribution piping for agriculture and livestock farming.

13. Method, according to claim 12, characterized in that the user of the system (100) can choose the intensity of both an electroacidification and an electroalkalinization and, thus, the desired ionization result, by selecting one or more of two or more options that will be assigned by the control unit processor (400) to the corresponding triple protocol(s).

14. An electroenergized fluid, characterized in that it is a final fluid (FF) obtained by electroenergizing an initial fluid (IF) through a system (100) as claimed in claim 12.

15. The electroenergized fluid according to claim 14, characterized in that it has a pH different from that of the initial fluid (IF) and a surface tension equal to or lower than the corresponding values of the initial fluid (IF).

16. A use of an electroenergized fluid, characterized in that it is of a fluid as claimed in claim 15 for supplying irrigation systems as well as for feeding and hydrating animals.
